(19) United States
(12) Patent Application Publication
(10) Pub. No.: US 2025/0002263 A1
(43) Pub. Date: Jan. 2, 2025

(54) DEVICE AND METHOD FOR TURNING FLAT WORKPIECES

(71) Applicant: OPTIMA life science GmbH, Schwäbisch Hall (DE)

(72) Inventor: Werner Volk, Michelfeld (DE)

(73) Assignee: OPTIMA life science GmbH, Schwäbisch Hall (DE)

(21) Appl. No.: 18/751,262

(22) Filed: Jun. 23, 2024

(30) Foreign Application Priority Data
Jun. 28, 2023 (DE) 102023117012.0

(51) Int. Cl. B65G 47/244

(52) U.S. Cl. CPC B65G 47/244; B65G 2201/022

(57) ABSTRACT

The invention relates to a turning device for turning flat workpieces comprising a first holding plate (41), a second holding plate (42) and an intermediate joint (43) arranged between the first holding plate (41) and the second holding plate (42), wherein the intermediate joint (43) is mounted so as to be displaceable perpendicularly to a running plane (40), wherein the first holding plate (41) and the second holding plate (42) are mounted in the running plane (40) via joints so as to be pivotable, wherein the first joint (412) and the second joint (422) are mounted so as to be displaceable along the running plane (40), wherein a drive device (44) is provided, by which the intermediate joint (43) can be driven to a displacement relative to the running plane (40), and wherein the intermediate joint (43), the first joint (412), the second joint (422), the first holding plate (41) and the second holding plate (42) form a folding mechanism, so that a displacement of the intermediate joint (43) away from the running plane causes a movement of the first holding plate (41) and the second holding plate (42) from working positions into transfer positions. The invention also relates to a method for turning flat workpieces and to a system comprising a turning device.

### CROSS-REFERENCE TO RELATED APPLICATION

The present application claims priority to German Patent Application No. 10 2023 117 012.0, filed Jun. 28, 2023, the entirety of which is incorporated herein by reference.

### TECHNICAL FIELD AND PRIOR ART

The invention relates to a turning device for turning flat workpieces and to a method for turning flat workpieces as well as to a system comprising a turning device.

In the context of the application, a flat workpiece is a single-layer or multi-layer product or educt which has a small thickness in relation to its surface area. In embodiments, the flat workpieces are flexible or elastically deformable. The flat workpieces can be made of different materials such as paper, cardboard, paperboard, metal and/or plastic films, metal and/or plastic meshes, coated and uncoated textile materials and/or mixed forms.

In particular, flat workpieces in the form of usually very sensitive membranes for fuel cells, redox flow batteries, electrolyzers and other applications are known, wherein stacks or laminates comprising the membranes and other flat workpieces must be formed during the production of the fuel cells, redox flow batteries, electrolyzers, etc.

For example, the flat workpiece is a catalyst-coated membrane (CCM) made of an ionomer for a fuel cell, wherein a gas diffusion layer (GDL) must be arranged on both sides of the CCM to produce a fuel cell. It is known to apply a partial seal between the CCM and the GDL. Depending on the definition, the CCM alone, the CCM with the two partial seals arranged on it or the entirety of the CCM, the two partial seals and the two GDLs is referred to as a membrane electrode assembly (MEA).

Depending on the specific use, the flat workpiece can also be the GDL for the fuel cell, which is made from a non-woven fabric or carbon paper, for example. In embodiments, the GDLs are manufactured in combination with electrodes, which are arranged on the side of the GDL facing the CCM.

A gas diffusion layer, a gas diffusion layer in combination with an electrode, a catalyst layer, a membrane, a catalyst-coated membrane or a catalyst-coated membrane in combination with a polymer film are generally referred to as a functional layer in the context of the application. The list is not exhaustive and alternative functional layers are conceivable.

It is known, for example, from DE 102021211386.9 to provide a device with two vacuum plates for cleaning and/or inspecting a functional layer with a first side and a second side, wherein the functional layer can be placed with the second side on a work surface of a first vacuum plate, so that the first side of the functional layer is exposed for cleaning and/or inspection, wherein the functional layer can be transferred to a second vacuum plate, wherein the functional layer is placed with the first side on a work surface of the second vacuum plate, so that the second side of the functional layer is exposed for cleaning and/or inspection, wherein the work surface of the first vacuum plate and the work surface of the second vacuum plate have the same orientation in a respective working position, and wherein one or both of the first vacuum plate and the second vacuum plate is pivoted for a transfer of the functional layer from the first vacuum plate to the second vacuum plate in such a way that the work surfaces are arranged opposite one another.

### OBJECT AND SOLUTION

It is the object of the invention to provide a device and a method for turning flat workpieces which, compared to known devices and methods, allows easier turning of the flat workpieces along a transport path of the flat workpieces.

According to a first aspect, a turning device for flat workpieces, in particular for turning a flat workpiece along a transport route, is provided, comprising a first holding plate, a second holding plate and an intermediate joint arranged between the first holding plate and the second holding plate, wherein the first holding plate can be arranged in a working position in which a work surface of the first holding plate is accessible for transferring a flat workpiece from a transport route to the work surface of the first holding plate, wherein the second holding plate can be arranged in a working position in which a work surface of the second holding plate is accessible for transferring the flat workpiece from the work surface of the second holding plate to the transport section, wherein the first holding plate and the second holding plate are each configured to apply a holding force to a flat workpiece arranged on the work surface as required, wherein the first holding plate and the second holding plate can each be pivoted from the working position into a transfer position, wherein, in the transfer position, the work surfaces of the first holding plate and the second holding plate are arranged opposite one another for transferring the flat workpiece, wherein the intermediate joint is mounted so as to be displaceable perpendicular to a running plane, wherein the first holding plate is mounted by a first joint in the running plane so as to be pivotable, wherein the second holding plate is mounted by a second joint in the running plane so as to be pivotable, wherein the first joint, the second joint and the intermediate joint have parallel pivot axes, wherein the first joint and the second joint are displaceably mounted along the running plane, wherein a drive device is provided with which the intermediate joint can be driven to a displacement relative to the running plane, and wherein the intermediate joint, the first joint, the second joint, the first holding plate and the second holding plate form a folding mechanism, so that a displacement of the intermediate joint away from the running plane causes a movement of the first holding plate and the second holding plate from the working positions into the transfer positions.

The terms “a”, “an” etc. are used in the context of the application as indefinite articles and not as counting words. Similarly, the terms “first” and “second” are used in the context of the application merely to differentiate and do not indicate an order. Also, the terms “first”, etc. do not necessarily require the presence of second identical or similar elements.

In one embodiment, the first joint and the intermediate joint are arranged on opposite edges of a rectangular work surface of the first holding plate. Similarly, the second joint and the intermediate joint are arranged on opposite edges of a rectangular work surface of the second holding plate. This ensures that the work surfaces are not moved across the running plane in a direction opposite the direction of movement of the intermediate joint during the pivoting movement into the transfer position. In other embodiments, the joints are arranged between the opposite edges. Depending on the positioning of the first joint and the second joint on the respective holding plate, an end opposite the intermediate joint is moved across the running plane during the pivoting movement.

The holding plate is designed in embodiments as a vacuum plate. A vacuum plate or vacuum table is a support on which components can be fixed using negative pressure. For this purpose, the vacuum plate has an air-permeable work surface, wherein air permeability can be realized by means of openings, porous materials and/or in other ways, depending on the specific use. The first and second holding plates together are also referred to as holding plates for short.

The working position of the holding plates refers to an arrangement of the holding plates in which a flat workpiece can be placed on a holding plate or picked up from it.

For a transfer between the holding plates, the work surfaces are arranged opposite each other and preferably in parallel, wherein, depending on the specific use, the work surfaces lie against each other or a gap remains between the work surfaces. If a gap remains, its size is selected in such a way that a safe transfer is guaranteed. In one embodiment, a gap dimension corresponds to a material thickness of the flat workpiece to be turned. In one embodiment, a gap dimension can be adjusted for adaptation to different flat workpieces.

In one embodiment, the first joint and the second joint are each slidably mounted in a rail.

In one embodiment, one or both of the work surface of the first holding plate and or the work surface of the second holding plate is/are aligned parallel to the running plane in the working position. The arrangement parallel to the running plane allows, in particular, access to the work surfaces for manual and/or automated placing of flat workpieces from a direction perpendicular to the running plane. In advantageous embodiments, the running plane is a horizontal plane so that no additional forces are required in the working position to pick up or hold the flat workpieces on the work surface.

According to a second aspect, a system comprising a transport section is provided, wherein flat workpieces can be transported along the transport section, and wherein a turning device for turning the flat workpieces is arranged on the transport section. In embodiments, the transport section comprises at least one gripper unit, which is set up to transport a flat workpiece to the turning device, to place it on the turning device and to pick up the turned flat workpiece again. Depending on requirements, all or only individual workpieces can be turned during transportation.

In one embodiment, the transport section has a linear section running parallel to the running plane, with the work surfaces of the holding plates facing the linear section in the working positions. The linear section allows fast and safe transportation. The turning device is operated in such a way that, during turning, elements of the turning device are not moved or are only moved insignificantly in the direction of the linear section. A gripper unit moving along the linear section can therefore remain in a waiting position at a safe distance from the turning device during turning.

In embodiments, the running plane of the turning device is a horizontal running plane, wherein the linear section is arranged above the running plane.

According to a third aspect, a method is provided for turning flat workpieces, in particular for turning flat workpieces along a transport path, using a turning device comprising a first holding plate, a second holding plate and an intermediate joint arranged between the first holding plate and the second holding plate, wherein before turning the flat workpiece is placed on a work surface of the first holding plate, which is arranged in a working position, and after turning is picked up from a work surface of the second holding plate, which is arranged in a working position, wherein for turning the flat workpiece the first holding plate and the second holding plate are each pivoted from the working position into a transfer position, wherein in the transfer position the work surfaces of the first holding plate and the second holding plate are arranged opposite one another for transferring the flat workpiece, wherein the intermediate joint is displaced perpendicularly to the running plane by a drive device, wherein displacement of the intermediate joint away from the running plane causes the first holding plate to pivot about a first pivot axis of a first joint, via which the first holding plate is mounted in the running plane so as to be pivotable, a pivoting of the second holding plate about a second pivot axis of a second joint, via which the second holding plate is mounted in the running plane so as to be pivotable, and a displacement of the first and second joints along the running plane, so that a displacement of the intermediate joint away from the running plane causes a movement of the first holding plate and the second holding plate from the working positions into the transfer positions.

In one embodiment, the first joint and the second joint are each moved along a rail. In this case, a displacement of the first joint and the second joint occurs passively due to the movement of the intermediate joint.

In embodiments, one or both of the work surface of the first holding plate and the work surface of the second holding plate is/are aligned parallel to the running plane in the working position.

For turning, in one embodiment the flat workpiece to be turned is transported to the turning device along a linear section of a transport path running parallel to the running plane and transported away from it after turning along the linear section.

### BRIEF DESCRIPTION OF THE DRAWINGS

Further advantages and aspects of the invention can be derived from the claims and the description of exemplary embodiments of the invention, which are explained below with reference to the figures, in which:

FIG. 1: shows schematically a system comprising a transport section for transporting a flat workpiece and a turning device for the flat workpiece;

FIG. 2: shows a detail of the system according to FIG. 1 when transferring a flat workpiece to the turning device;

FIG. 3: shows the turning device of the system according to FIG. 1 when turning the workpiece; and

FIG. 4: shows a detail of the system according to FIG. 1 when transferring a flat workpiece to the turning device.

### DETAILED DESCRIPTION OF THE EXEMPLARY EMBODIMENTS

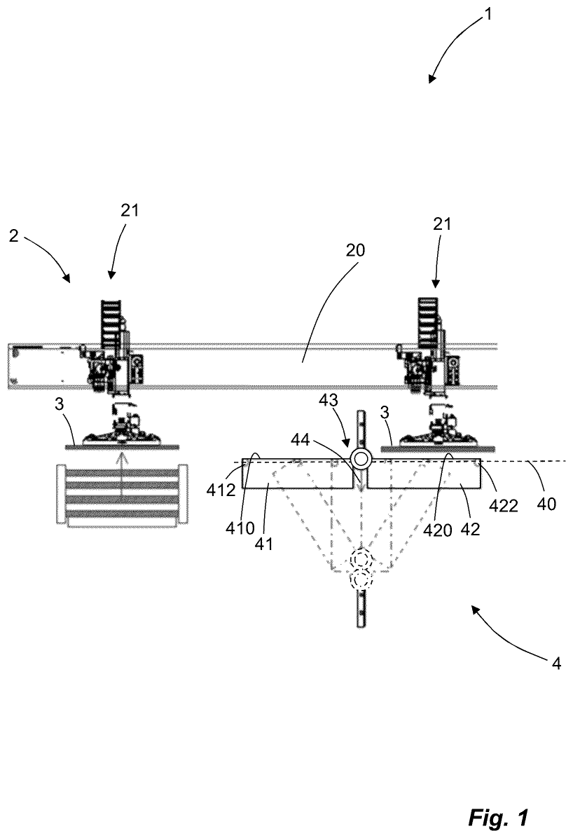

FIG. 1 schematically shows a system 1 comprising a transport section 2 for transporting a flat workpiece 3, a turning device 4 for turning the flat workpiece 3 and a supply 5, by means of which a number of flat workpieces 3 are provided.

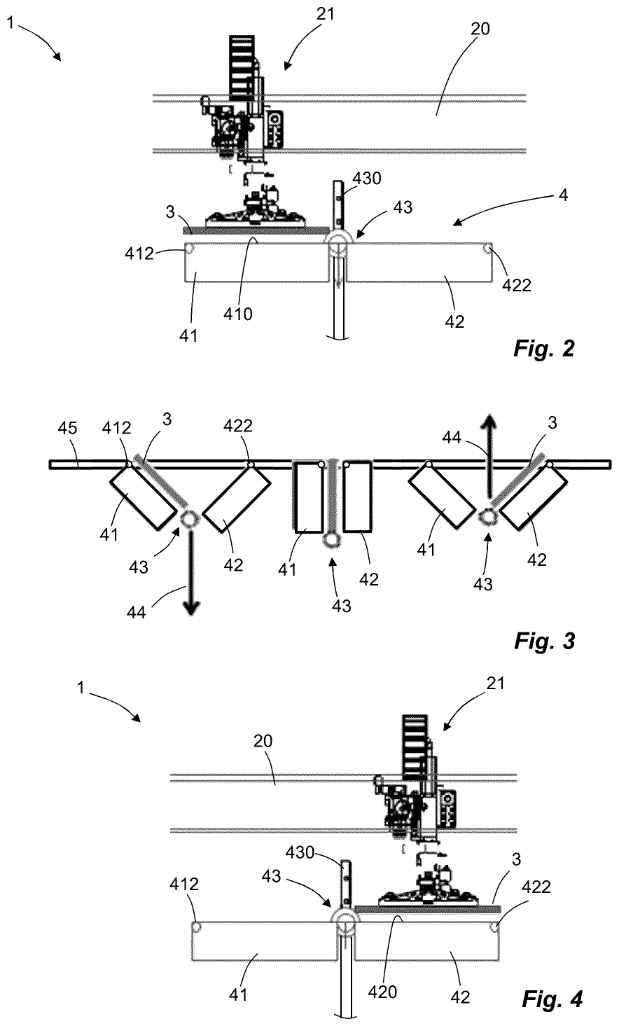

FIGS. 2 and 4 show a detail of the system 1 according to FIG. 1 when transferring a flat workpiece 3 to the turning device 4 or when picking up a turned flat workpiece 3 from the turning device 4.

FIG. 3 shows the turning device 4 in various states when turning the workpiece 3.

The turning device 4 comprises a first holding plate 41 with a first work surface 410, a second holding plate 42 with a second work surface 420, an intermediate joint 43 arranged between the first holding plate 41 and the second holding plate 42, a first joint 412, a second joint 422 and a drive device 44 shown by an arrow.

The intermediate joint 43, the first joint 412 and the second joint 413 have pivot axes that are parallel to each other. The first holding plate 41 is pivotably mounted in a running plane 40 by means of the first joint 412. The second holding plate 42 is pivotably mounted in the running plane 40 by means of the second joint 422. In the illustrated exemplary embodiment, the first joint 412 and the intermediate joint 43 are arranged at opposite edges of the rectangular work surface 410. Similarly, the second joint 422 and the intermediate joint 43 arranged at opposite edges of the rectangular work surface 420. In other embodiments, the joints 412, 422 are arranged between the opposing edges.

The first holding plate 41 can be arranged in a working position shown in FIG. 1 with a solid line and in FIG. 2, in which the work surface 410 of the first holding plate 41 is accessible for transferring a flat workpiece 3 from the transport section 2 to the work surface 410 of the first holding plate 41. In the illustrated exemplary embodiment, the first holding plate 41 is arranged in the working position in such a way that the work surface 410 lies in a horizontal plane.

The second holding plate 42 can be arranged in a working position, also shown with a solid line in FIG. 1, in which the work surface 420 of the second holding plate 42 is accessible for transferring the flat workpiece 3 from the work surface 420 of the second holding plate 42 to the transport section 2. In the illustrated exemplary embodiment, the second holding plate 42 is arranged in the working position in such a way that the work surface 420 lies in a horizontal plane, wherein the work surfaces 410, 420 in the illustrated exemplary embodiment are arranged in the working positions of a common plane parallel to the rail 20 of the transport section 2.

The first holding plate 41 and the second holding plate 42 can each be pivoted from the working position shown by solid lines in FIG. 1 into a transfer position shown by a dotted line in FIG. 1, wherein in the transfer position the work surfaces 410 of the first holding plate 41 and the second holding plate 42 are arranged opposite one another for transferring the flat workpiece 3 from the first holding plate 41 to the second holding plate 42.

The intermediate joint 43 is displaceably mounted perpendicular to the running plane 40. In the illustrated exemplary embodiment, the intermediate joint 43 is displaceably mounted by means of a rail 430. By means of the drive device 44, the intermediate joint 43 can be driven to a displacement relative to the running plane 44 along the rail 430.

The first joint 412 and the second joint 422 are displaceably mounted along the running plane 40 by means of a rail (see FIG. 3).

The intermediate joint 43, the first joint 412, the second joint 422, the first holding plate 41 and the second holding plate 42 form a folding mechanism, so that a displacement of the intermediate joint 43 away from the running plane 40 causes a movement of the first holding plate 41 and the second holding plate 42 from the working positions to the transfer positions.

Due to the arrangement of the first joint 412 and the second joint 422 at the edges of the rectangular work surface 410, 420, the movement of the holding plates 41, 42 into the transfer positions takes place in such a way that the holding plates 41, 42 do not project or project only insignificantly from the running plane 40 in the direction of the transport path 2 during the movement.

The illustrated transport section 2 comprises a linear section with a rail 20 and at least one gripper unit 21 which can be moved along the rail 20. The gripper unit 21 j set up and configured to remove a flat workpiece 3 from the supply 5, to transport the flat workpiece 3 along the rail 20 to the turning device 4 and to place it on the work surface 410 of the first holding plate 41. The turning device 4 can then be operated so that the work surfaces 410, 420 are pivoted from the working position into the transfer position as shown in FIG. 3. The gripper unit 21 can remain in a waiting position above the turning device 4. After turning, the turned flat workpiece 3 is arranged on the work surface 420 of the second holding plate 42 and can be picked up by the gripper unit 21.

FIG. 1 schematically shows two gripper units 21 operating in parallel, wherein the gripper units 21 can each be moved back and forth along a section of the rail 20 in one embodiment. A first gripper unit 21 removes a workpiece 3 from the supply 5 and transports it to the turning device 4. By means of a second gripper unit 21, the turned workpiece 3 is picked up from the device 4 and transported away for further processing.

In other embodiments, only one gripper unit 21 is provided or several gripper units 21 are provided, which are moved, for example, along a closed path comprising the linear section shown.

The turning device 4 allows the flat workpiece 3 to be turned during transportation along the transport section 2.

In specific uses of the system 1, the flat workpiece 3 is a workpiece with a low inherent rigidity, for example a membrane for fuel cells, redox flow batteries, electrolyzers and other applications and/or a functional layer to be directly or indirectly connected to the membrane.

1. A turning device for flat workpieces, in particular for turning flat workpieces along a transport path, comprising a first holding plate, a second holding plate and an intermediate joint arranged between the first holding plate and the second holding plate, wherein the first holding plate can be arranged in a working position in which a work surface of the first holding plate is accessible for transferring a flat workpiece from a transport section to the work surface of the first holding plate, wherein the second holding plate can be arranged in a working position in which a work surface of the second holding plate is accessible for transferring the flat workpiece from the work surface of the second holding plate to the transport section, wherein the first holding plate and the second holding plate are each configured to apply a holding force to a flat workpiece arranged on the work surface, and wherein the first holding plate and the second holding plate can each be pivoted from the working position into a transfer position, wherein, in the transfer position, the work surfaces of the first holding plate and the second holding plate are arranged opposite one another for transferring the flat workpiece, wherein the intermediate joint is mounted so as to be displaceable perpendicular to a running plane, wherein the first holding plate is mounted by a first joint in the running plane so as to be pivotable, wherein the second holding plate is mounted by a second joint in the running plane so as to be pivotable, wherein the first joint, the second joint and the intermediate joint have parallel pivot axes, wherein the first joint and the second joint are displaceably mounted along the running plane, wherein a drive device is provided, with which the intermediate joint can be driven to a displacement relative to the running plane, and wherein the intermediate joint, the first joint, the second joint, the first holding plate and the second holding plate form a folding mechanism, so that a displacement of the intermediate joint away from the running plane causes a movement of the first holding plate and the second holding plate from the working positions into the transfer positions.

2. The turning device according to claim 1, wherein the first joint and the second joint are each displaceably mounted in a rail.

3. The turning device according to claim 1, wherein one or both of the work surface of the first holding plate and or the work surface of the second holding plate is/are aligned parallel to the running plane in the working position.

4. A system comprising a transport section, wherein flat workpieces can be transported along the transport section, wherein a turning device for turning the flat workpieces according to claim 1 is arranged on the transport section.

5. The system according to claim 4, wherein the transport section has a linear section running parallel to the running plane, wherein the work surfaces of the holding plates face the linear section in the working positions.

6. The system according to claim 5, wherein the running plane is a horizontal running plane, the linear section being arranged above the running plane.

7. A method for turning flat workpieces, in particular for turning flat workpieces along a transport path, using a turning device comprising a first holding plate, a second holding plate and an intermediate joint arranged between the first holding plate and the second holding plate, wherein before turning the flat workpiece is placed on a work surface of the first holding plate, which is arranged in a working position, and after turning is picked up from a work surface of the second holding plate, which is located in a working position, wherein for turning the flat workpiece the first holding plate and the second holding plate are pivoted from the working position into a transfer position, wherein the work surfaces of the first holding plate and of the second holding plate are arranged opposite one another in the transfer position for transferring the flat workpiece from the first holding plate to the second holding plate, wherein the intermediate joint is displaced perpendicularly to the running plane by a drive device, wherein a displacement of the intermediate joint away from the running plane causes the first holding plate to pivot about a first pivot axis of a first joint, via which the first holding plate is mounted so as to be pivotable in the running plane, a pivoting of the second holding plate about a second pivot axis of a second joint, via which the second holding plate is mounted so as to be pivotable in the running plane, and a displacement of the first and second joints along the running plane, so that a displacement of the intermediate joint away from the running plane causes a movement of the first holding plate and the second holding plate from the working positions into the transfer positions.

8. The method according to claim 7, wherein the first joint and the second joint are each displaced along a rail.

9. The method according to claim 7, wherein one or both of the work surface of the first holding plate and the work surface of the second holding plate is/are aligned parallel to the running plane in the working position.

10. The method according to claim 7, wherein the flat workpiece is transported along a linear section of a transport path running parallel to the running plane to the turning device and, after turning, is transported away from the latter along the linear section.
